(19) United States
(12) Patent Application Publication
(10) Pub. No.: US 2026/0180307 A1
(43) Pub. Date: Jun. 25, 2026

(54) ARC FLASH LIMITER

(71) Applicant: Schneider Electric USA, Inc., Boston, MA (US)

(72) Inventors: Alan SCHMIDT, Marion, IA (US); Clinton Carne, Cedar Rapids, IA (US); William Brown, Cookeville, TN (US); Patrick Perron, Moirans (FR)

(21) Appl. No.: 18/987,610

(22) Filed: Dec. 19, 2024

(51) Int. Cl. H02H 3/16; H02H 1/00

(52) U.S. Cl. CPC H02H 3/16; H02H 1/0015

(57) ABSTRACT

An arc flash protection system and method are used to generate a worst-case arc-flash incident energy for downstream electrical equipment based at least on device information obtained for the downstream electrical equipment, constant arc-flash incident energy curves based upon the parameters of the downstream equipment, and the tripping time/current characteristics determined for a primary electrical protective device associated with the downstream electrical equipment. An arc flash label for the downstream electrical equipment is generated based at least on the worst-case arc-flash incident energy generated for the downstream electrical equipment. In a local hosting embodiment, the primary electrical protective device is configured for determining the worst-case arc-flash incident energy for downstream electrical equipment connected thereto. In an external hosting embodiment, an arc flash labeling computer is configured to provide sophisticated outputs in addition to determining the worst-case arc-flash incident energy for downstream electrical equipment connected to a primary electrical protective device.

### FIELD

The present disclosure generally relates to an arc flash protection system for labeling electrical equipment.

### BACKGROUND

The National Electric Code (NEC) and the Standard for Electrical Safety in the Workplace (NFPA 70E) require arc flash labeling for electrical equipment. Furthermore, NFPA 70E requires arc flash labeling to be updated anytime the electrical equipment is modified (e.g., settings for the equipment are modified, the equipment is moved, etc.). NFPA 70E also requires that arc flash labeling for electrical equipment is reviewed every five years at a minimum to ensure the labeling is up-to-date. In general, arc flash labels are crucial to industrial safety, as they explain hazards associated with electrical equipment in industrial settings, and the procedures and protective equipment necessary for safely interacting with the electrical equipment. For example, arc flash labels provide information regarding incident energy released during an arc flash event involving the electrical equipment such that the appropriate level of arc flash personal protective equipment (PPE) to be worn when working on or near the electrical equipment can be selected.

### SUMMARY

Aspects of the present disclosure provide systems and methods for efficiently generating arc flash labeling for electrical equipment.

One aspect of the present disclosure involves a primary electrical protective device configured for arc-flash labeling downstream electrical equipment associated with it and comprises a protective device processor and a non-transitory storage medium coupled to the protective device processor. The storage medium stores processor-executable arc-flash incident energy instructions that, when executed, cause the protective device processor to retrieve a time-current characteristic for the primary electrical protective device and device information for the downstream electrical equipment. The instructions further cause the processor to obtain a constant arc-flash incident energy curve based at least on the device information retrieved for the downstream electrical equipment and process the time-current characteristic, device information, and constant arc-flash incident energy curve with an arc-flash incident energy model to output a worst-case arc-flash incident energy and arc-flash boundary for the downstream electrical equipment.

In another aspect, a computer-implemented method for updating an arc-flash label generated for downstream electrical equipment comprises outputting, at a primary electrical protective device associated with the downstream electrical equipment, a current worst-case arc-flash incident energy for the downstream electrical equipment. The method also includes detecting, at the primary electrical protective device, a change in at least one of device information for the primary electrical protective device and device information for the downstream electrical equipment and outputting, at the primary electrical protective device, an updated worst-case arc-flash incident energy for the downstream electrical equipment based at least on the change.

Another aspect involves calculation of the maximum available arc-flash incident energy and arc-flash boundary at the operatively connected downstream electrical equipment, then using constant-energy curve data to adjust the time-current characteristics of the primary electrical equipment to deliver at that downstream equipment the maximum arc-flash incident energy specified by the user and corresponding arc-flash boundary if such is achievable.

In yet another aspect, an arc flash protection system comprises a primary electrical protective device and an arc-flash labeling computer. The primary electrical protective device is configured to execute processor-executable arc-flash incident energy instructions to output an arc-flash incident energy and arc-flash boundary for downstream electrical equipment associated with the primary electrical protective device. The arc-flash labeling computer is operatively connected to the primary electrical protective device for loading the arc-flash incident energy from the primary electrical protective device. The arc-flash labeling computer is configured to generate a sophisticated informative output based at least on the arc-flash incident energy and arc-flash boundary retrieved from the primary electrical protective device.

In an additional aspect, a formal engineering study has been performed upon the power system and available arc-flash incident energy and associated arc-flash boundary have been calculated in that study for applicable electrical equipment. These calculations are based upon time-current characteristics for each protective device, which are themselves based upon the recommended pickup and timing settings as applicable for each protective device. The primary protective device is programmed with the study-recommended pickup and timing settings and resulting arc-flash incident energy, arc-flash boundary, and arcing current at the operably-connected downstream piece of equipment based upon these settings. For applicable changes to pickup and timing settings of the primary protective device, the primary protective device will re-calculate and display the arc-flash incident energy and corresponding arc-flash boundary for the operably-connected downstream equipment and retain this information. Similarly, the primary protective device would be capable of recommending setting changes based upon a user-requested level of arc-flash incident energy and the downstream equipment if such is achievable.

Other objects and features will be in part apparent and in part pointed out hereinafter.

### BRIEF DESCRIPTION OF THE DRAWINGS

FIG. 1A is a schematic diagram illustrating an arc flash protection system, according to an embodiment.

FIG. 1B is another schematic diagram illustrating an arc flash protection system, according to an embodiment.

FIG. 1C is another schematic diagram illustrating an arc flash protection system, according to an embodiment.

FIG. 2 is a schematic diagram illustrating an example primary electrical protective device and a plurality of downstream electrical equipment of the arc flash protection system shown in FIG. 1, according to an embodiment.

FIG. 3 is a flow chart illustrating an example of a method of generating an arc flash label, according to an embodiment.

FIG. 4 is a graph illustrating an example of Time-Current Curves and Constant Energy Curves, according to an embodiment.

FIG. 5 is a schematic block diagram illustrating an example scenario of using the arc flash protection system of FIG. 1, according to an embodiment.

FIG. 6 is a graph illustrating an example of a worst-case incident energy curve, according to an embodiment.

FIG. 7 is a flow chart illustrating an example of a method for determining an impact of modifying device information for electrical equipment, according to an embodiment.

Corresponding reference characters indicate corresponding parts throughout the drawings.

### DETAILED DESCRIPTION

Arc flash labels are required on electrical equipment (indoor and outdoor) used by facilities covered by the National Electric Code (NEC) such as, for example, industrial plants. Generally, arc flash labels include information for the electrical equipment such as a warning indicating hazards (e.g., arc flash) of the electrical equipment, an incident energy determined for the electrical equipment, an arc flash boundary, a nominal voltage, a working distance, and/or an arc flash PPE category. The available arc-flash incident energy at a piece of equipment indicates the potential thermal burn severity of an arc flash occurrence at that equipment. An arc flash boundary for electrical equipment refers to the minimum distance from exposed energized electrical components where the incident energy equals 1.2 cal/cm² in the case of an arc flash occurrence. The nominal voltage of electrical equipment refers to a typical electrical voltage of the equipment during normal operations. Working distance refers to the distance a worker (e.g., a worker's face and chest area) is spaced apart from the electrical equipment while working on the equipment. An arc flash PPE category (also rated by incident energy level) indicates the level of PPE necessary for interacting with the electrical equipment. Conventional systems and processes for generating arc flash labels for electrical equipment generally involve intensive studies performed for each individual piece of electrical equipment. Accordingly, with conventional systems and processes for generating arc flash labels, each time an arc flash label needs to be created, modified, and/or reviewed for a piece of electrical equipment, a considerable amount of resources are required. Aspects of the present disclosure achieve arc flash label generation by utilizing electrical equipment data, protective device time-current characteristics, and arc-flash constant incident energy curves included in the protective devices to generate worst-case arc flash labels for electrical equipment. As will be described in further detail below, this disclosure pertains to systems and methods for effectively generating, modifying, and reviewing arc flash labels for electrical equipment.

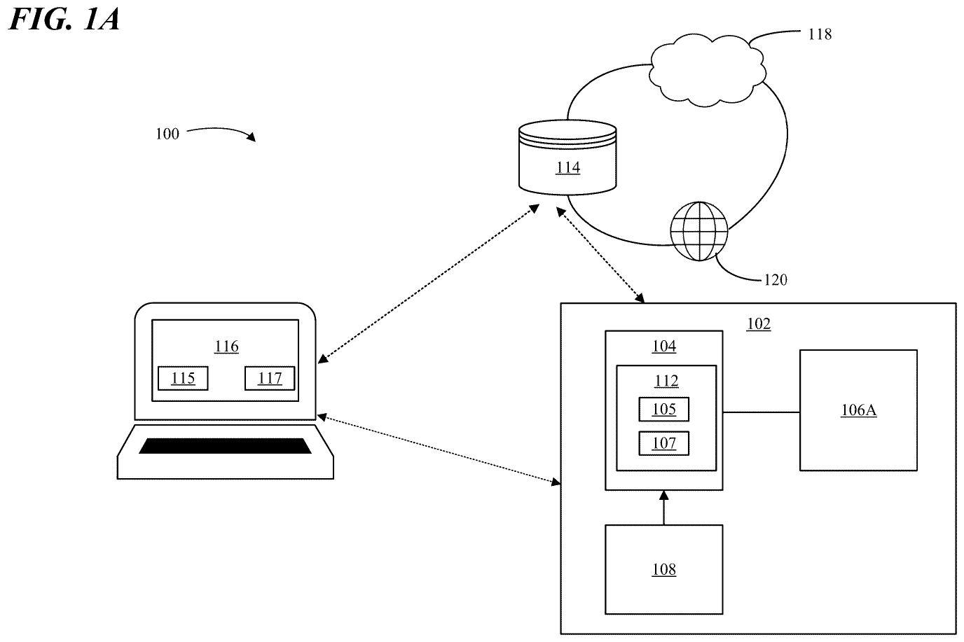

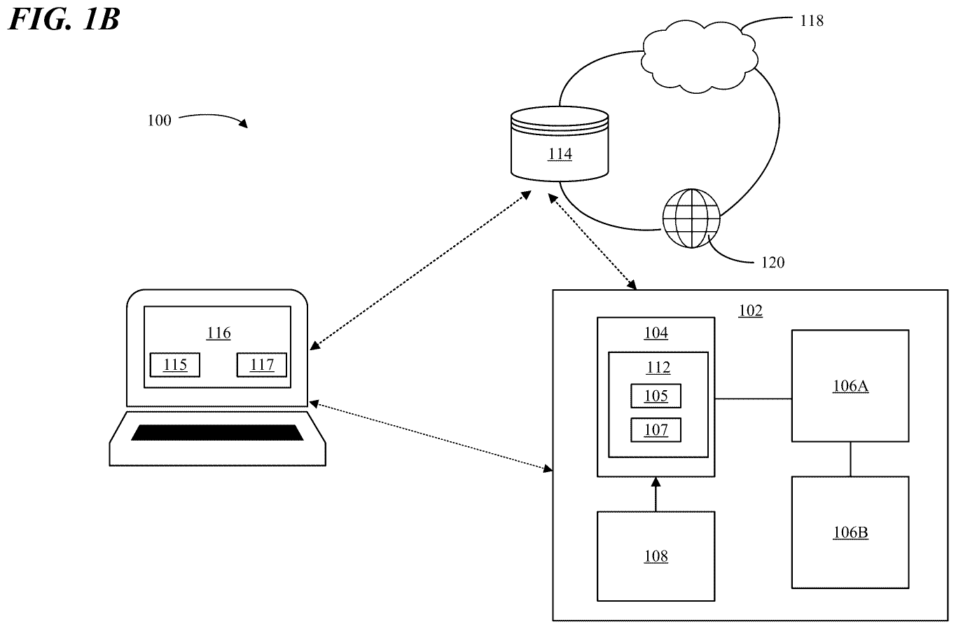

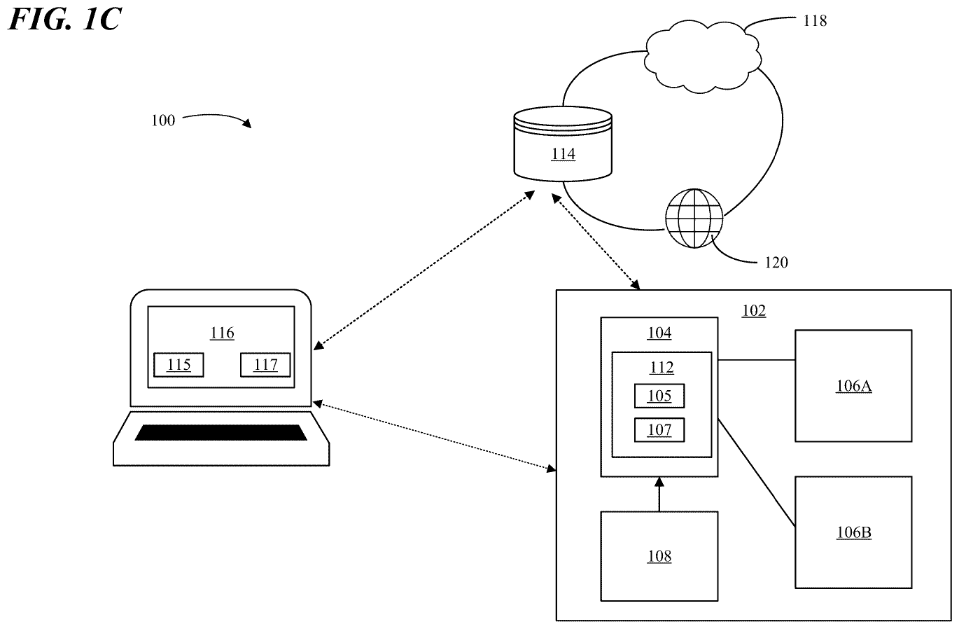

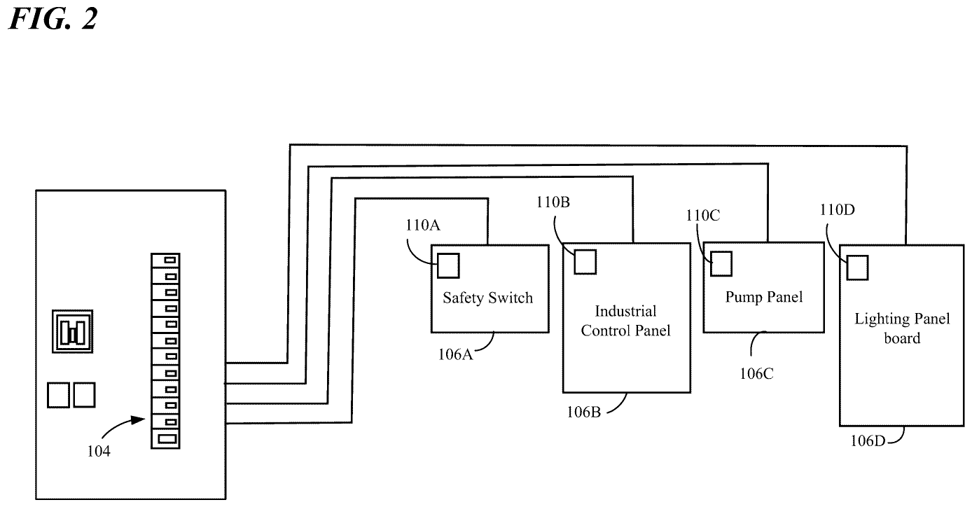

Referring now to FIGS. 1A-1C, an example arc flash protection system is generally indicated at reference number 100. In the illustrated embodiments, the arc flash protection system 100 is configured for use in an industrial plant 102, however it is also contemplated that the arc flash protection system may be used in any type of system for various types of electrical equipment installed both indoors and outdoors. The arc flash protection system 100 is configured for generating and/or modifying an arc flash label for electrical equipment in the industrial plant 102. In the illustrated embodiment, the electrical equipment comprises a primary electrical protective device 104 and one or more downstream electrical equipment associated with the primary electrical protective device 104. In the illustrated example shown in FIG. 1A a single piece of downstream electrical equipment 106A is connected to the primary electrical protective device 104, whereas FIGS. 1B-2 show additional pieces of downstream electrical equipment (e.g., 106B-106D) connected to the primary electrical protective device 104. Suitably, systems and methods described herein are configured to accommodate single and multiple downstream equipment scenarios.

In an example local host embodiment, the arc flash protection system 100 broadly comprises the primary electrical protective device 104 and at least one downstream electrical equipment 106A operatively connected to the electrical protective device 104. As will be described in further detail below, the primary electrical protective device 104 is configured to calculate the available arc-flash incident energy and associated arc-flash boundary for the downstream electrical equipment 106A connected thereto, based upon the time-current characteristics of the primary protective device 104, constant arc-flash incident energy curves, and device information obtained for the downstream electrical equipment 106A.

The system 100 may further include a labeling system 108 operatively connected to at least the primary electrical protective device 104. The labeling system 108 is configured to create an arc flash label 110A for the downstream electrical equipment 106A based at least on the calculated incident energy provided for the downstream electrical equipment 106A. Generally, arc flash labels are applied to a door, cover, or other removable panel that is a part of the electrical equipment, such that the arc flash labels may easily be viewed by those individuals working with or in the general area of the electrical equipment. Individual components of the arc flash protection system 100 in the local host embodiment will now be described before turning to an external host embodiment of the arc flash protection system 100.

In the local host embodiment, the primary electrical protective device 104 comprises a processor 105 and a memory 107 (shown in FIGS. 1A-1C). The primary electrical protective device 104 may also comprise user inputs, a display, and other related elements. The primary electrical protective device 104 may also include circuit boards and/or other electronic components such as a transceiver or external connection for communicating with other electrical equipment within the industrial plant 102. For example, the primary electrical protective device 104 includes components such as wireless transceivers and/or wired connectors that connect the primary electrical protective device 104 to one or more downstream electrical equipment 106A-106D and the labeling system 108. In one example, the primary electrical protective device 104 comprises a circuit breaker for the industrial plant 102. However, it is contemplated that the primary electrical protective device 104 may include different electrical equipment within the industrial plant 102 without departing from the scope of the present disclosure. In one example, the primary electrical protective device 104 comprises a trip unit 112 that includes the processor 105 and the memory 107 (FIGS. 1A-1C). In one example, the primary electrical protective device 104 is operatively connected to and comprises a display that is configured to display at least one of the worst-case calculated incident energy determined for each of the downstream electrical equipment 106A-106D. Moreover, the display is configured to display a digital version of one or more arc flash labels 110A-110D determined for the downstream electrical equipment 106A-106D to one or more plant operators. Plant operators refer to those individuals generally associated with and/or affected by the electrical equipment.

In an example embodiment, the primary electrical protective device 104 is configured to store at least some device information (and potential device information) such as safety and operating information for the primary electrical protective device 104 and optionally the one or more downstream electrical equipment 106A-106D connected thereto, in the memory 107 of the primary electrical protective device 104. Device information includes, but is not limited to, input data for generating the worst-case arc-flash incident energy and arc-flash boundary for the downstream electrical equipment 106A-D and input data for generating the worst-case arc flash labels 110A-110D for each of the downstream electrical equipment 106A-106D. In one example, the device information comprises a gap size between main and/or downstream electrodes of the electrical equipment, a voltage range for the electrical equipment, a working distance determined for the electrical equipment, a rated current range for electrical equipment, an enclosure size of the electrical equipment, a conductor style/configuration for the electrical equipment, potential hazards, and pick-up settings for the electrical equipment. The memory 107 may also store constant energy curve data to be used in generating the worst-case incident energy for equipment 110A-110D

In another embodiment, at least one of the device information (and potential device information) for the primary electrical protective device 104 and downstream electrical equipment 106A-106D, and constant energy curve data are stored in a database 114 associated with and operably connected to at least the primary electrical protective device 104. Furthermore, the database 114 may include device information and constant energy curve data from at least one of the primary electrical protective device 104, the downstream electrical equipment 106A-106D, a data system of the industrial plant 102 (e.g., an industrial control system of the industrial plant), the cloud 118, and other web sources 120.

In the local host embodiment, the memory 107 is also configured to store processor-executable worst-case arc-flash incident energy instructions, that when executed by the processor 105, cause the processor to calculate a worst-case arc-flash incident energy for the primary electrical protective device 104, and provide a corresponding worst-case arc-flash incident energy for each of the downstream electrical equipment 106A-106D based upon the time-current characteristics of the primary electrical protective device, constant arc-flash energy curves, and device information for each corresponding downstream electrical equipment 106A-106D. Device information includes, but is not limited to, input data for generating the worst-case arc-flash incident energy for the downstream electrical protective equipment 106A. In one example, the device information comprises a gap size between main and/or downstream electrodes of the electrical equipment, a voltage range for the electrical equipment, a working distance determined for the electrical equipment, and an enclosure size of the electrical equipment.

In one example, the processor-executable instructions comprise instructions for the processor 105 to execute to (I) retrieve device information for the primary electrical protective device 104 (e.g., from the memory 107 and/or database 114), (II) plot a Time-Current Curve for the primary electrical protective device 104 based on the device information, (III) retrieve constant energy curve data (e.g., from the memory 107 and/or database 114), (IV) plot at least one Constant Energy Curve based on the constant energy curve data, on top of the Time-Current Curve, (V) retrieve device information for the downstream electrical equipment 106A (e.g., from the memory 107 and/or database 114), (VI) compare the Constant Energy Curve to the Time-Current Curve to provide worst-case arc-flash incident energy and associated arc-flash boundary for downstream equipment 106A. These instructions may be re-executed to provide the worst-case arc-flash incident energy for each of the other downstream electrical equipment 106B-106D connected to the primary electrical protective device 104.

Optionally, the processor-executable worst-case arc-flash incident energy instructions may also cause the processor 105 to load the worst-case incident energy for the downstream electrical equipment 106A to the labeling system 108 for generating the arc flash label 110A for at least the downstream electrical equipment 106A. Furthermore, the processor-executable worst-case arc-flash incident energy instructions may also cause the processor 105 to load device information for the downstream electrical equipment 106A to the labeling system for generating the arc flash label to include at least one of a hazard associated with the downstream electrical equipment 106A, an arc flash boundary for the downstream electrical equipment 106A, a nominal voltage for the downstream electrical equipment 106A, a working distance for the downstream electrical equipment 106A, and an arc flash personal protective equipment category for the downstream electrical equipment 106A in addition to the worst-case arc-flash incident energy for the downstream electrical equipment 106A. Similarly arc flash labels 110B-110D may also be generated for the downstream electrical equipment 106B-106D.

The instructions may also cause the processor 105 to display at least one worst-case incident energy determined for the one or more downstream electrical equipment 106A-106D to one or more plant operators. The worst-case arc-flash incident energy instructions may also cause the processor 105 to store the calculated worst-case incident energy for at least one of the primary electrical protective device 104 and downstream electrical equipment 106A-106D in at least one of the memory 107 and database 114. The instructions may also cause the processor 105 to store the arc flash labels 110A-110D generated for the downstream electrical equipment 106A-106D in at least one of the memory 107 and database 114.

In another example, the worst-case arc-flash incident energy instructions, when executed by the processor 105, may also cause the processor 105 to detect a modification made to the device information for at least one of the primary electrical protective device 104 and downstream electrical equipment 106A. Suitably, once a modification is detected, the worst-case arc-flash incident energy instructions cause the processor to provide a worst-case arc-flash incident energy and associated arc-flash boundary for at least one of the downstream electrical equipment 106A-106D based on the modified device information.

In another example, the instructions further comprise change feedback instructions that, when executed by the processor 105, cause the processor to (1) obtain potential device information for the primary electrical protective device that comprises a change from the device information (e.g., from user inputs, the memory 107, and/or database 114). For example, the potential device information comprises device information based on modifications made to device settings of the primary electrical protective device 104. Furthermore, the change feedback instructions cause the processor to (II) plot a potential Time-Current Curve for the primary electrical protective device 104 based on the potential device information, (III) plot at least one Constant Energy Curve based on the constant energy curve data, on top of the potential Time-Current Curve, and (IV) calculate the impact the change has on the worst-case arc-flash incident energy and associated arc-flash boundary for at least one of devices 106A-106D.

Determining the impact the change has on the arc-flash incident energy at at least one of equipment 106A-106D enables plant operators to determine the impact a modification made to the primary electrical protective device 104 has on the electrical hazards at equipment 106A-106D. Moreover, this provides an updated worst-case arc-flash incident energy for the primary electrical protective device 104 that considers modifications made to the primary electrical protective device 104 affecting a change in the device information. The change instructions may also cause the processor 105 to load at least one of the potential device information and potential worst-case arc-flash incident energy for the downstream electrical equipment 106A to the labeling system 108 for generating an updated arc flash label for the downstream electrical equipment 106A-106D.

Optionally, a formal engineering study has been created, with calculated arc-flash incident energies and arcing current levels at downstream equipment 106A-106D based upon existing or recommended settings for primary protective device 104. The information from this engineering study is loaded into at least one of memory 107, database 114, or cloud 118. The instructions cause processor 105, when presented with potential changes to settings for primary protective device 104, to use the arcing current levels at equipment 106A-106D along with the change in operating time of protective device 104 at these arcing current levels to calculate an updated arc-flash incident energy and associated arc-flash boundary equipment 106A-106D and store it in at least one of memory 107, database 114, or cloud 118.

In the illustrated example of FIG. 2, the downstream electrical equipment 106A-106D operatively connected to the primary electrical protective device 104, comprises a safety switch (downstream electrical equipment 106A), an industrial control panel (downstream electrical equipment 106B), a pump panel (downstream electrical equipment 106C), and a lighting panel board (downstream electrical equipment 106D). However, it is contemplated that the downstream electrical equipment 106A-106D may include different types of electrical equipment, as well as a different number of electrical equipment without departing from the scope of the present disclosure.

The labeling system 108 (FIGS. 1A-1C) is operatively connected to the memory 107 and processor 105 of the primary electrical protective device 104 for loading the worst-case arc-flash incident energy and associated arc-flash boundary calculated for each of the downstream electrical equipment 106A-106D. Furthermore, the labeling system 108 is configured to create an arc flash label 110A-110D for each of the downstream electrical equipment based at least on the worst-case arc-flash incident energy for the downstream equipment. Furthermore, the labeling system 108 is configured to use the device information (obtained from the memory 107 and/or database 114 (FIGS. 1A-1C)) for the downstream electrical equipment 106A-106D to generate each of the arc flash labels 110A-110D to include further information on the arc flash labels 110A-11D. For example, each of the arc flash labels 110A-110D generated for the downstream electrical equipment 106A-106D are configured to include the corresponding worst-case arc-flash incident energy, an arc flash boundary for the downstream electrical equipment, a nominal voltage for the downstream electrical equipment, a working distance for the downstream electrical equipment, and an arc flash personal protective equipment category for the downstream electrical equipment. In one example, the labeling system 108 is also configured to generate duplicates of the arc flash labels 110A-D that may be applied to the primary electrical protective device 104. In one example, the labeling system 108 broadly comprises a computer and a printer. However, other equipment capable of creating arc flash labels may be used without departing from the scope of the present disclosure.

In the external host embodiment, some components of the arc flash protection system 100 (FIGS. 1A-1C) operate in a similar manner to the local host environment embodiment, however one difference includes that an arc flash labeling computer 116 is used to calculate the worst-case arc-flash incident energy for the one or more downstream electrical equipment 106A-106D connected to the primary electrical protective device 104. This is particularly advantageous in instances where a sophisticated computing environment is necessary. For example, this embodiment enables worst-case arc-flash incident energy and arc flash labels to be created for less sophisticated electrical equipment 106A-106D that are not capable of communicating equipment data to the primary electrical protective device 104, or where primary electrical protective device 104 is not sophisticated enough to process the required instructions for arc-flash incident energy calculation. Furthermore, the sophisticated computing environment of the external host environment achieves more sophisticated outputs explaining the generated worst-case arc-flash incident energy and arc flash labels. Examples of the individual components of the arc flash protection system 100 in the external host embodiment will now be described before turning to example computer-implemented methods for generating arc flash labels for electrical equipment.

In one example of the external host embodiment, the primary electrical protective device 104 is less sophisticated than the arc flash labeling computer 116. For example, the primary electrical protective device 104 is not capable of gathering equipment data for, or calculating the worst-case arc-flash incident energy and associated arc-flash protection boundary for downstream equipment. However, it is contemplated that the external host embodiment may also be used to generate a worst-case arc-flash incident energy for a relatively sophisticated primary electrical protective device 104 that is capable of such calculations. In one example, the primary electrical protective device 104 comprises a circuit breaker for the industrial plant 102. However, it is contemplated that the primary electrical protective device 104 may include different electrical equipment within the industrial plant 102 without departing from the scope of the present disclosure.

In an example embodiment, the primary electrical protective device 104 is configured to store at least some device information (and potential device information) such as safety and operating information for the primary electrical protective device 104 and optionally the one or more downstream electrical protective devices 106A-106D connected thereto, in the memory 107 of the primary electrical protective device 104. Device information includes, but is not limited to, input data for generating the worst-case arc-flash incident energy for the downstream electrical protective equipment 106A-D and input data for generating the arc flash label(s). In one example, the device information comprises a gap size between main and/or downstream electrodes of the electrical equipment, a voltage range for the electrical equipment, a working distance determined for the electrical equipment, a rated current range for electrical equipment, an enclosure size of the electrical equipment. The memory 107 may also store constant energy curve data to be used in generating the worst-case arc-flash incident energy for the primary electrical protective device 104.

In another embodiment, at least one of the device information (and potential device information) for the primary protective device 104 and downstream electrical equipment 106A-106D, and constant energy curve data are stored in the database 114 associated with and operably connected to the arc flash labeling computer 116. The database 114 may include device information and constant energy curve data from at least one of the primary electrical protective device 104, downstream electrical equipment 106A-106D, a data system of the industrial plant 102 (e.g., an industrial control system of the industrial plant), the cloud 118, and other web sources 120.

The arc flash labeling computer 116 broadly comprises a processor 115 and a memory 117. In one embodiment, at least one of the device information (and potential device information) for the primary protective device 104 and downstream electrical equipment 106A-106D, and constant energy curve data are stored in the memory 117. Moreover, the arc flash labeling computer 116 may include user inputs, a display, and other elements. The arc flash labeling computer 116 includes circuit boards and/or other electronic components such as a transceiver or external connection for communicating with other computing devices of the system 100. Although the illustrated arc flash labeling computer 116 is schematically represented as a single laptop/desktop computer, it will be understood that the arc flash labeling computer can comprise other types of computing resources, e.g., one or more local computer devices and/or one or more remote computational resources (e.g., cloud computing resources).

The arc flash labeling computer 116 includes components such as wireless transceivers and/or wired connectors that connect the it to the database 114, the cloud 118, other web sources 120, a digital twin associated with the electrical equipment (e.g., a digital twin of the industrial plant 102), the primary electrical protective device 104, the downstream electrical equipment 106A-106D, and the labeling system 108. For example, the arc flash labeling computer 116 is operably connected to at least one of the primary electrical protective device 104, and the database 114 for loading device information and constant arc-flash incident energy curve data. In another embodiment, the arc flash labeling computer 116 is operatively connected to the labeling system 108 for creating an arc flash label 110A for the downstream electrical equipment 106A based on the corresponding device information and worst-case arc-flash incident energy. In another embodiment, the arc flash labeling computer 116 itself is configured to generate an arc flash label 110A for the downstream electrical equipment 106A based on the corresponding device information and worst-case arc-flash incident energy. In either case, arc flash labels 110B-11D may be similarly generated for the downstream electrical equipment 106B-106D.

In general, the memory 117 of the arc flash labeling computer 116 is configured to store processor-executable worst-case arc-flash incident energy instructions that, when executed by the processor 115 of the arc flash labeling computer 116, cause the processor 115 to calculate the worst-case arc-flash incident energy for the downstream electrical equipment 106A associated with the primary electrical protective device 104 based at least on the device information and constant energy curve data (obtained from at least one of the memory 107 of the primary electrical protective device, memory 117 of the arc flash labeling computer 116, the database 114) and device information for the downstream electrical equipment 106A. These instructions may be re-executed to provide the worst-case arc-flash incident energy for each of the other downstream electrical equipment 106B-106D connected to the primary electrical protective device 104.

In one example, the processor-executable worst-case arc-flash incident energy instructions comprise instructions for the processor 115 to execute to (I) retrieve device information for the primary electrical protective device 104 (e.g., from the memory 107 of the primary electrical protective device, memory 117 of the arc flashing labeling computer 116, and/or database 114), (II) plot a Time-Current Curve for the primary electrical protective device 104 based on the device information, (III) retrieve constant energy curve data (e.g., from the memory 107 and/or database 114), (IV) plot at least one Constant Energy Curve based on the constant energy curve data, on top of the Time-Current Curve, (V) compare the Constant Energy Curve to the Time-Current Curve to provide the worst-case arc-flash incident energy for the downstream electrical equipment 106A. These instructions may be re-executed to provide the worst-case arc-flash incident energy for each of the other downstream electrical equipment 106B-106D connected to the primary electrical protective device 104.

In one embodiment, the processor-executable worst-case arc-flash incident energy instructions may also cause the processor 115 to load the device information and worst-case arc-flash incident energy for the downstream electrical equipment 106A, to the labeling system 108 for generating an arc flash label 110A for the downstream electrical equipment 106A. In another embodiment, the processor-executable worst-case arc-flash incident energy instructions, when executed by the processor 115, further cause the processor to generate the arc flash label 110A for the downstream electrical equipment 106A based at least on the worst-case arc-flash incident energy provided for the downstream electrical equipment 106A. Moreover the processor-executable worst-case arc-flash incident energy instructions in one embodiment, instruct the processor 115 to generate the arc flash label 110A to include the corresponding worst-case arc-flash incident energy determined for the downstream electrical protective equipment 106A and at least one of a hazard associated with the downstream electrical equipment 106A, an arc flash boundary for the downstream electrical equipment 106A, a nominal voltage for the downstream electrical equipment 106A, a working distance for the downstream electrical equipment 106A, and an arc flash personal protective equipment category for the downstream electrical equipment 106A obtained by the processor 115. Suitably, the arc flash labeling computer 116 may include or be operatively connected to the labeling system 108 for loading and printing the arc flash label 110A. Similarly, arc flash labels 110B-110D may also be generated and printed for the downstream electrical equipment 106B-106D.

Optionally, the worst-case arc-flash incident energy instructions may also cause the processor 115 to display at least one of the worst-case arc-flash incident energy generated for the primary electrical protective 104, arc flash label(s) 110A-110D and worst-case arc-flash incident energy determined for the one or more downstream electrical equipment 106A-106D, to one or more plant operators. The worst-case arc-flash incident energy instructions may also cause the processor 115 to store the calculate and store worst-case arc-flash incident incident energy for at least one of the primary electrical protective device 104 and downstream electrical equipment 106A-106D in at least one of the memory 107, memory 117, and database 114. The instructions may also cause the processor 105 to store the arc flash labels 110A-110D generated for the downstream electrical equipment 106A-106D in at least one of the memory 107, memory 117, and database 114. The worst-case arc-flash incident energy instructions may also cause the processor 115 to modify at least some of the device information for at least one of the primary electrical protective device 104 and downstream electrical equipment 106, based at least on the corresponding determined worst-case arc-flash incident energy. The worst-case arc-flash incident energy instructions may also cause the processor 115 to load at least one of the corresponding worst-case arc-flash incident energy and arc flash label to at least one of the primary electrical protective device 104, database 114, and one or more downstream electrical equipment 106A-106D.

In another example, the instructions, when executed by the processor 115, may also cause the processor 115 to detect a modification made to the device information for at least one of the primary electrical protective device 104 or downstream electrical equipment 106A. Suitably, once a modification is detected, the instructions cause the processor 115 to provide an updated worst-case arc-flash incident energy for downstream electrical equipment 106A based on the modified device information. Furthermore, an updated arc label may be generated based on the updated worst-case arc-flash incident energy.

The change instructions, when executed by the processor 115, further cause the processor 115 to provide a potential worst-case arc-flash incident energy for the downstream electrical equipment 106A based at least on the potential worst-case arc-flash incident energy provided for the primary electrical protective device 104 and device information for the downstream electrical equipment 106A to determine the impact the change has on the worst-case arc-flash incident energy for the downstream electrical equipment 106A. This enables plant operators to determine the impact a modification made to the primary electrical protective device 104 has on downstream electrical equipment 106A-106D.

The change instructions may also cause the processor 115 to load the potential device information and potential worst-case arc-flash incident energy for one or more of the downstream electrical equipment 106A-106D to the labeling system 108 for generating updated arc flash labels for the electrical equipment. The change instructions may also cause the processor 115 to generate the arc flash labels using the arc flash labeling computer 116 itself.

Optionally, a formal engineering study has been created, with calculated arc-flash incident energies and arcing current levels at downstream equipment 106A-106D based upon existing or recommended settings for primary protective device 104. The information from this engineering study is loaded into at least one of memory 107, database 114, or cloud 118. The instructions cause processor 115, when presented with potential changes to settings for primary protective device 104, to use the arcing current levels at equipment 106A-106D along with the change in operating time of protective device 104 at these arcing current levels to calculate an updated arc-flash incident energy and associated arc-flash boundary equipment 106A-106D and store it in at least one of memory 107, database 114, or cloud 118.

In another embodiment, the change instructions may also cause the processor 115 of the arc flash labeling computer 116 to (1) obtain current device information for electrical equipment (e.g., primary or downstream) of the industrial plant 102, (II) obtain potential device information for the electrical equipment, wherein the potential device information comprises a change from the current device information, (III) determine a current worst-case arc-flash incident energy for the electrical equipment based at least on the current device information, (IV) determine a potential worst-case arc-flash incident energy for the electrical equipment based at least on the potential device information, (V) update a digital twin associated with the electrical equipment based on the current worst-case arc-flash incident energy to provide a current state digital twin, (VI) update the digital twin based on the potential worst-case arc-flash incident energy to provide a potential state digital twin, (VII) compare the current state digital twin to the potential state digital twin to determine an impact of the change on the electrical equipment, and (VIII) provide to one or more plant operators via a display (e.g., of the arc flash labeling computer 116), at least one of the current worst-case arc-flash incident energy for the electrical equipment, potential worst-case arc-flash incident energy for the electrical equipment, current state digital twin, potential state digital twin, and the determined impact of the change. Thus, the external host embodiment enables more sophisticated outputs such as digital twins to be provided for explaining worst-case arc-flash incident energy for electrical equipment.

In the external host embodiment, the downstream electrical equipment 106A-106D are generally configured in the same manner as described in the local host embodiment. Similarly, the labeling system 108 is generally configured in the same manner as described in the local host embodiment.

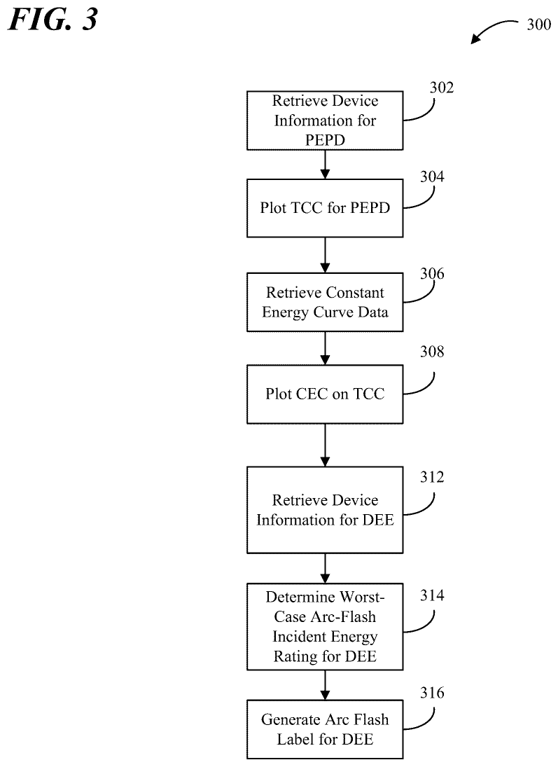

Referring now to FIG. 3, an example of a computer-implemented method for arc flash labeling electrical equipment is generally indicated at reference number 300. Accordingly, the method 300 may be executed by the arc flash protection system 100 (FIGS. 1A-1C) in the local and external host embodiments.

The method 300 begins at step 302 wherein device information for a primary electrical protective device (PEPD) 104 is retrieved. For example, a processor 105, 115 retrieves device information for the PEPD 104 from at least one of a memory 107 of the PEPD 104, memory 117 of the arc flash labeling computer 116, and a database 114 associated with the PEPD 104. Next, a Time-Current Curve (TCC) for the PEPD 104 is plotted based on the retrieved device information (step 304). At step 306, constant energy curve (CEC) data is retrieved. For example, a processor 105, 115 retrieves the CEC data for the downstream equipment 106A-106D from at least one of a memory 107 of the PEPD 104, a database 114 associated with the PEPD 104, the cloud 118, devices 106A-106D, and/or other web sources 120. From here at least one CEC, based on the constant energy curve data, is plotted on top of the TCC (step 308).

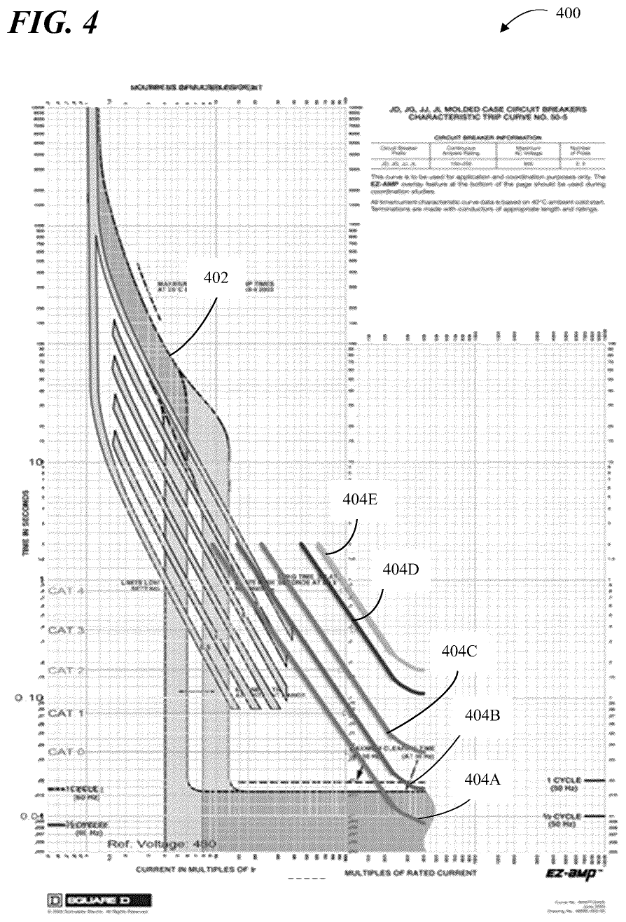

FIG. 4 provides an example embodiment of a graph 400 comprising the TCC 402 and one or more CECs 404A-404E. With the graph 400, time is represented by the Y-axis, and rated current is represented by the X-axis. Accordingly, the TCC 402 shows the time it takes an electrical protective device to trip and the rated current level at which the electrical protective device trips. The CECs 404A-404E correspond to different boundaries wherein the incident energy from an arc flash reaches a specific predetermined level. The CECs 404A-404E may also be a direct indication of the constant incident energy level. The graph 400 is only to be interpreted as a non-limiting example, as higher and lower levels of CEC's may be plotted above, below, and in between all of the CECs 404A-404E shown in FIG. 4.

For explanatory purposes, the specific predetermined levels may indicate different levels of required PPE for interacting with the electrical equipment according to updated standards. For example, scenarios under CEC 404A require Category 0 PPE. Scenarios under CEC 404B, but above CEC 404A require Category 1 PPE. Scenarios under CEC 404C, but above CEC 404B require Category 2 PPE. Scenarios under CEC 404D, but above CEC 404C require Category 3 PPE. Scenarios under CEC 404E, but above CEC 404D require Category 4 PPE.

Referring Back to FIG. 3, At step 312 device information for downstream electrical equipment (DEE) 106A associated with the PEPD 104 is retrieved. For example, a processor 105, 115 retrieves device information for the DEE 106A from at least one of the memory 107, memory 117, and database 114.

At step 314, a worst-case arc-flash incident energy DEE 106A is determined based on the worst-case arc-flash incident energy determined for the PEPD 104 and device information obtained for the downstream electrical equipment (DEE) 106A. For example, the PEPD 104 TCC curves 402 have numerous settings that may be selected. These TCC curves represent the band at which the PEPD 104 will trip at for the range of currents that may flow through the device. The upper portion of the TCC bands represents the longest trip time the PEPD 104 will take to open and extinguish the current. Alternatively, each CEC curve represents the combinations of current duration and current level that will result in the arc flash incident energy at the level specified in the curve definition at downstream equipment. Therefore, as long as the PEPD 104 TCC curve remains below and to the left of the CEC curve on a time/current plot with time on the vertical axis and current on the horizontal axis, it can be stated that the PEPD 104 will release downstream less incident energy than the rating of the CEC curve. The PEPD 104 determines how long current will flow through it at various current levels. The resultant current that passes through PEPD 104 then flows downstream. In this example it is presumed that the current is flowing into an arcing fault inside the DEE 106A. It is the release of the arcing energy associated with this current that comprises the arc flash event. The magnitude of the arcing energy release is directly proportional to the time the arcing current is allowed to flow, which is controlled by the tripping time of PEPD 104. The maximum arcing time considered is 2 s, as allowed by the IEEE 1584-2018 standard.

Finally, at step 316 an arc flash label 110A for the DEE 106A is generated based at least on the worst-case arc-flash incident energy determined for the DEE 106A, and applied to the DEE 106A. The arc flash label 110A may also be generated based on the device information for the DEE 106A, to include at least one of a hazard associated with the DEE 106A, an arc flash boundary for the DEE 106A, a nominal voltage for the DEE 106A, a working distance for the DEE 106A, and an arc flash personal protective equipment category for the DEE 106A obtained by the processor 105, 115. In one example, the arc flash label 110A is generated by the arc flash labeling computer 116, and printed using the arc flash labeling system 108. From here, the arc flash label 110A may be applied to the DEE 106A. In an optional step, at least one of the worst-case arc-flash incident energy for the PEPD 104 and DEE 106A are displayed to one or more plant operators. Similarly arc flash labels 110B-11D may also be generated and printed for the downstream electrical equipment 106B-106D.

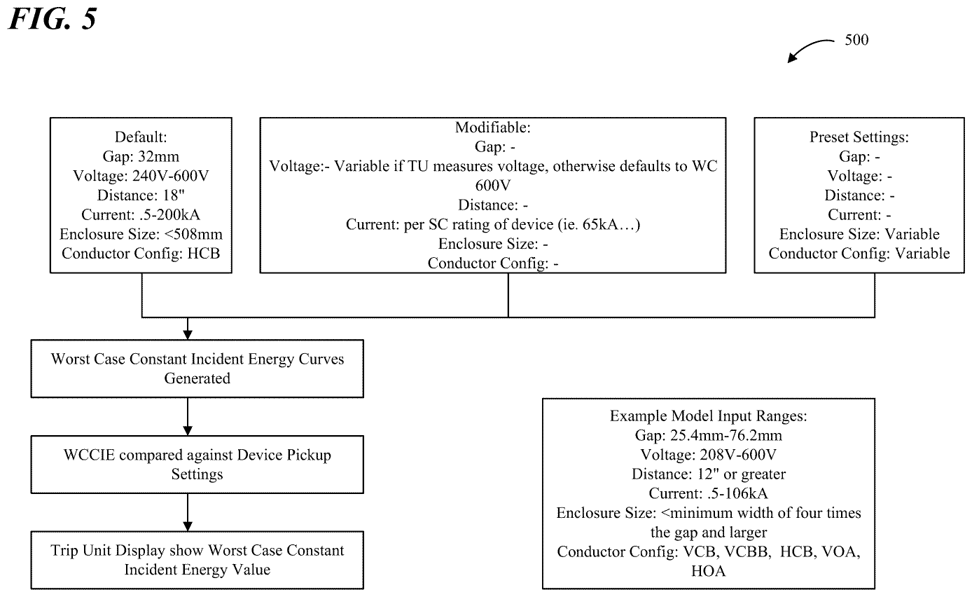

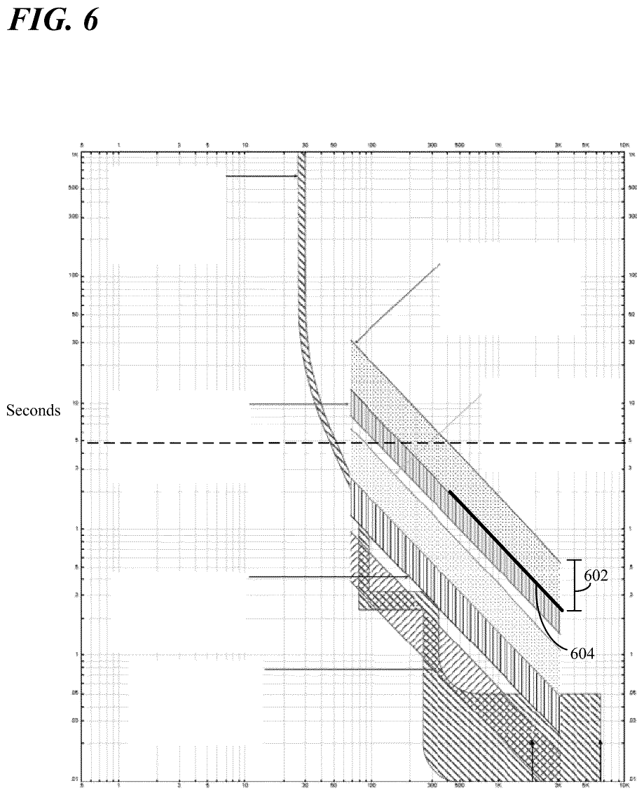

Referring now to FIG. 5, an example scenario of using systems and methods in accordance with the present disclosure to determine a worst-case arc-flash (e.g., worst-case) incident energy for electrical equipment is generally indicated at reference number 500. In general, device information for the electrical equipment is used to generate a worst-case arc-flash incident energy. There are numerous models available globally to calculate the arc flash incident energy for electrical equipment. One or more calculation models are used to calculate the incident energy value. Some examples of calculation models used to generate the incident energy value include, but are not limited to, IEEE 1584 and the Ralph Lee model. Typical input parameters (device information) that are required to calculate the incident energy level are shown in 500, but additional or less parameters maybe utilized in various arc flash models to calculate incident energy. In general, the model is configured to accept a wide range of types and values of inputs to more accurately calculate the arc flash incident energy. Through analysis of each model, it is possible to determine which types of input under which specific values result in the worst-case incident energy. For example, in FIG. 6, input values for the IEEE 1584 model are varied in the shaded region 602, which can result in a 40 cal/cm² exposure. The worst-case model can be represented by the lowest line 604 that can be drawn along the bottom of the shaded region 602. In other words, the lowest line 604 represents the worst-case incident energy curve at 40 cal/cm². Accordingly, the worst-case incident energy value generated for a primary electrical protective device 104 may be used to determine a worst-case incident energy value for downstream electrical equipment 106A connected to the primary electrical protective device 104.

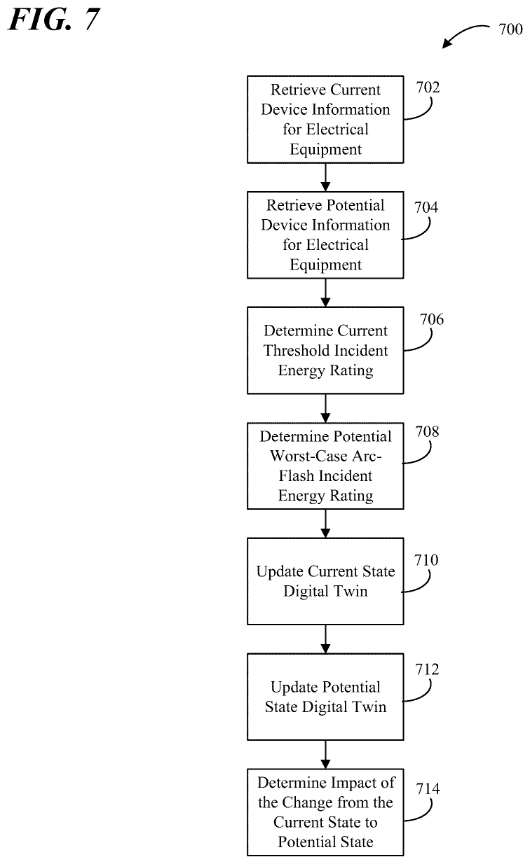

Referring now to FIG. 7, another example of a computer-implemented method for arc flash labeling electrical equipment is generally indicated at reference number 700.

At step 702, current device information for electrical equipment is retrieved or inputted in the case of less sophisticated devices that cannot communicate with other components for retrieving the device information. In one example, a processor 115 retrieves current device information for the electrical equipment from at least one of a memory 107 of the electrical equipment and a database 114 associated with the electrical equipment. In another example, at least some of the device information is retrieved from a trip unit 112 of the electrical equipment. At step 704, potential device information for the electrical equipment is retrieved. The potential device information comprises a change or modification to the current device information. In one example, the processor 115 retrieves the potential device information from at least one of one or more user inputs, the memory 107 of the electrical equipment, and the database 114 associated with the electrical equipment.

At step 706, a current worst-case arc-flash incident energy for the electrical equipment is determined based at least on the current device information. In one example, the current worst-case arc-flash incident energy for the electrical equipment is determined using the steps for determining the worst-case arc-flash incident energy for the downstream electrical equipment 106A-106D in the method 300 above. In another example, the current worst-case arc-flash incident energy for the electrical equipment is determined by matching the current device information to a corresponding pre-loaded worst-case arc-flash incident energy for the current device information. Similarly, at step 708 the potential worst-case arc-flash incident energy for the electrical equipment is determined based at least on the potential device information. In one example, the potential worst-case arc-flash incident energy for the electrical equipment is determined using the steps for determining the worst-case arc-flash incident energy for the downstream electrical equipment 106A-106D described in the method 300 above. In another example, the potential worst-case arc-flash incident energy for the electrical equipment is determined by matching the potential device information to a corresponding pre-loaded worst-case arc-flash incident energy for the potential device information.

At step 710, a digital twin associated with the electrical equipment (e.g., a digital twin for the industrial plant 102) is updated based on the current worst-case arc-flash incident energy to provide a current state of the digital twin. At step 712, the digital twin is updated based on the potential worst-case arc-flash incident energy to provide a potential state of the digital twin. At step 714, the current state of the digital twin is compared to the potential state of the digital twin to determine an impact of the change on electrical equipment of the facility.

In an example, the electrical equipment of the method 700 comprises a primary electrical protective device 104, and the method further involves determining a current worst-case arc-flash incident energy for a downstream electrical equipment 106A connected to the primary electrical protective device 104 based on the current device settings of the primary electrical protective device 104 and device information retrieved for the downstream electrical equipment 106A, and updating the current state digital twin based on the current worst-case arc-flash incident energy for the downstream electrical equipment 106A.

Optionally, the method 700 may include providing to one or more plant operators via a display, at least one of the current worst-case arc-flash incident energy for the downstream electrical equipment 106A-106D, potential worst-case arc-flash incident energy for the downstream electrical equipment 106A-106D, current state digital twin, potential state digital twin, and the determined impact of the change.

In an example embodiment, the method 700 includes printing an arc flash label for the downstream electrical equipment 106A based at least on the current worst-case arc-flash incident energy for the downstream electrical equipment 106A. Moreover, an arc flash label for the downstream electrical equipment 106A may be printed based on the potential worst-case arc-flash incident energy for the downstream electrical equipment 106A to account for modifications made to at least one of the primary electrical protective device 104 and downstream electrical equipment 106A. Similarly arc flash labels may also be generated and printed for other downstream electrical equipment 106B-106D connected to the primary electrical protective device 104.

Embodiments of the present disclosure comprise a special purpose computer including a variety of computer hardware, as described in greater detail herein and are operational with other special purpose computing system environments or configurations even if described in connection with an example computing system environment. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices. For purposes of illustration, programs and other executable program components may be shown as discrete blocks. It is recognized, however, that such programs and components reside at various times in different storage components of a computing device, and are executed by a data processor(s) of the device.

In operation, processors, computers, and/or servers may execute the processor-executable instructions (e.g., software, firmware, and/or hardware) such as those illustrated herein to implement aspects of the invention. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the present disclosure.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A primary electrical protective device configured for arc-flash labeling downstream electrical equipment associated with the primary electrical protective device, the primary electrical protective device comprising:
a protective device processor; and
a non-transitory storage medium coupled to the protective device processor, the storage medium storing processor-executable arc-flash incident energy instructions that, when executed, cause the protective device processor to:
retrieve a time-current characteristic for the primary electrical protective device,
retrieve device information for the downstream electrical equipment,
obtain a constant arc-flash incident energy curve based at least on the device information retrieved for the downstream electrical equipment, and
process the time-current characteristic, device information, and constant arc-flash incident energy curve with an arc-flash incident energy model to output a worst-case arc-flash incident energy rating for the downstream electrical equipment.

2. The primary electrical protective device of claim 1, wherein the non-transitory storage medium of the primary electrical protective device is configured to store at least one of the time-current characteristic for the primary electrical protective device, the constant arc-flash incident energy curve, and the device information for the downstream electrical equipment.

3. The primary electrical protective device of claim 1, wherein the arc-flash incident energy instructions, when executed, further cause the protective device processor to generate the constant arc-flash incident energy curve based at least on the device information retrieved for the downstream electrical equipment.

4. The primary electrical protective device of claim 1, wherein the arc-flash incident energy instructions, when executed, further cause the protective device processor to retrieve device information for the primary electrical protective device and generate the time-current characteristic based at least on the device information retrieved for the primary electrical protective device.

5. The primary electrical protective device of claim 1, being operatively connected to a database for loading at least one of the time-current characteristic for the primary electrical protective device, device information for the downstream electrical equipment, and the constant arc-flash incident energy curve.

6. The primary electrical protective device of claim 1, being operatively connected to the downstream electrical equipment for loading at least one of the device information for the downstream electrical equipment and the constant arc-flash incident energy curve from the downstream electrical equipment.

7. The primary electrical protective device of claim 1, wherein the arc-flash incident energy instructions, when executed, further cause the protective device processor to retrieve a second arc-flash incident energy rating determined for the downstream electrical equipment and compare the second arc-flash incident energy rating with the worst-case arc-flash incident energy rating to determine a relationship therebetween.

8. The primary electrical protective device of claim 7, wherein the arc-flash incident energy instructions, when executed, further cause the protective device processor to use the relationship determined between the second arc-flash incident energy rating and the worst-case arc-flash incident energy rating to output at least one of an updated second arc-flash incident energy rating and updated worst-case arc-flash incident energy rating for the downstream electrical equipment when a change is made to at least one of device information for the primary electrical protective device and device information for the downstream electrical equipment.

9. The primary electrical protective device of claim 8, wherein the second arc-flash incident energy rating determined for the downstream electrical equipment comprises an exact arc-flash incident energy value determined for the downstream electrical equipment.

10. The primary electrical protective device of claim 7, wherein the non-transitory storage medium stores the second arc-flash incident energy rating.

11. The primary electrical protective device of claim 7, wherein the arc-flash incident energy instructions, when executed, further cause the protective device processor to generate the second arc-flash incident energy rating.

12. The primary electrical protective device of claim 1, wherein the arc-flash incident energy instructions, when executed, further cause the protective device processor to send the worst-case arc-flash incident energy rating for the downstream electrical equipment to a labeling system for creating an arc-flash label for the downstream electrical equipment based at least on the worst-case arc-flash incident energy rating for the downstream electrical equipment.

13. The primary electrical protective device of claim 1, being configured for low power usage.

14. A computer-implemented method for updating an arc-flash label generated for downstream electrical equipment, the method comprising:
outputting, at a primary electrical protective device associated with the downstream electrical equipment, a current arc-flash incident energy rating for the downstream electrical equipment,
detecting, at the primary electrical protective device, a change in at least one of device information for the primary electrical protective device and device information for the downstream electrical equipment; and
outputting, at the primary electrical protective device, an updated arc-flash incident energy rating for the downstream electrical equipment based at least on the change.

15. The computer-implemented method of claim 14, further comprising generating a user alert when the change is detected to notify a user that an updated arc-flash label for the downstream electrical equipment is required.

16. An arc-flash protection system comprising:
a primary electrical protective device configured to execute processor-executable arc-flash incident energy instructions to output an arc-flash incident energy rating for downstream electrical equipment associated with the primary electrical protective device; and
an arc-flash labeling computer operatively connected to the primary electrical protective device for loading the arc-flash incident energy rating from the primary electrical protective device, the arc-flash labeling computer configured to generate a sophisticated informative output based at least on the arc-flash incident energy rating retrieved from the primary electrical protective device.

17. The arc-flash protection system of claim 16, wherein the sophisticated informative output comprises at least one of an arc-flash label for the downstream electrical equipment, a digital twin associated with the primary electrical protective device and downstream electrical equipment, and an information board associated with the primary electrical protective device and downstream electrical equipment.

18. The arc-flash protection system of claim 17, wherein the arc-flash labeling computer is further configured to obtain at least one of a hazard associated with the downstream electrical equipment, an arc-flash boundary for the downstream electrical equipment, a nominal voltage for the downstream electrical equipment, a working distance for the downstream electrical equipment, and an arc-flash personal protective equipment category for the downstream electrical equipment for generating the sophisticated informative output.

19. The arc-flash protection system of claim 17, wherein the arc-flash labeling computer is configured to determine a second arc-flash incident energy rating determined for the downstream electrical equipment and compare the second arc-flash incident energy rating with the arc-flash incident energy rating retrieved from the primary electrical protective device to determine a relationship therebetween, and wherein the arc-flash labeling computer is configured to use the relationship determined between the second arc-flash incident energy rating and the arc-flash incident energy rating retrieved from the primary electrical protective device to generate one or more additional sophisticated informative outputs based thereon.

20. The arc-flash protection system of claim 16, wherein the arc-flash labeling computer comprises an edge-level device.
